(19) United States
(12) Patent Application Publication
(10) Pub. No.: US 2011/0060862 A1
(43) Pub. Date: Mar. 10, 2011

(54) Systems and Methods for Switchable Memory Configuration

(75) Inventor: Robert W. Warren, Loveland, CO (US)

(73) Assignee: LSI Corporation

(21) Appl. No.: 12/716,262

(22) Filed: Mar. 2, 2010

Related U.S. Application Data
(60) Provisional application No. 61/240,486, filed on Sep. 8, 2009.

(51) Int. Cl. G06F 13/28; G06F 12/02; G06F 13/36; G06F 13/00

(52) U.S. Cl. 711/103; 710/22; 711/E12.008; 710/306; 710/317

(57) ABSTRACT

Various embodiments of the disclosure provide systems, methods and circuits for implementation and use of a memory system. As one example, a memory system is disclosed that includes a plurality of memory devices and a configuration circuit. The configuration circuit includes at least one input, a plurality of outputs, and a programmable control circuit. The plurality of outputs are communicably coupled to the plurality of memory devices, and the programmable control circuit is operable to selectably couple the input to at least one of the plurality of outputs.

### CROSS REFERENCE TO RELATED APPLICATIONS

The present application claims priority to (is a non-provisional of) U.S. Pat. App. No. 61/240,486, entitled “Cross-bar Approach to Allow for Programmable Flash Memory Lane Configuration”, and filed Sep. 8, 2009 by Warren. The entirety of the aforementioned provisional patent application is incorporated herein by reference for all purposes.

### BACKGROUND

The present disclosure is related to systems and methods for configurable memory systems, and more particularly to systems and methods that allow for matching a memory system to one or more system requirements.

Flash memories have been used in a variety of devices where information stored by the device must be maintained even when power is lost to the device. FIG. 1 shows an example flash memory system 100 that includes flash memory devices 140, 150, 160, 170 each including an interface with a clock, a clock enable, a command/response (CMD/RESP) input, and a Data input/output. Flash memory devices 140, 150 are attached to a data bus 106, and flash memory devices 160, 170 are attached to data bus 126. Each of data buses 106, 126 may be referred to as lanes. Such lanes are defined by the bandwidth and Input/output Operations Per Second (hereinafter “IOPS”) that can be performed. By combining a number of lanes in parallel, the number of IOPS and/or bandwidth of a flash memory system may be increased.

The number of parallel lanes is limited by the pin count required by each of flash memory devices 140, 150, 160, 170 to support each lane. Flash memory system 100 includes two lanes where each lane includes two flash memory devices associated with each lane. Each lane requires a unique set of chip enable (CE) and command response (CMD/RESP) for each device included on the lane. In addition, the lane requires a shared eight bit bus and clock (CK). Assuming that the time required from a request until 4K of data is obtained from a given one of flash memory devices 140, 150, 160, 170 is one-hundred, fifty microseconds, the total number of IOPS per lane is 6.66 k IOPS. Where each device is capable of supporting 27 MHz of bandwidth, the combination of two devices (i.e., flash memory devices 140, 150; or flash memory devices 160, 170) is capable of supporting 54 MHz of bandwidth and 6.6 k IOPS per lane where the two devices are properly interleaved, but it does not provide for other implementations.

Hence, for at least the aforementioned reason, there exists a need in the art for advanced systems and methods for implementing memories.

### BRIEF SUMMARY

The present disclosure is related to systems and methods for configurable memory systems, and more particularly to systems and methods that allow for matching a memory system to one or more system requirements.

Various embodiments provide memory systems that include a plurality of memory devices and a configuration circuit. The configuration circuit includes at least one input, a plurality of outputs, and a programmable control circuit. The plurality of outputs are communicably coupled to the plurality of memory devices, and the programmable control circuit selectably couples the input to at least one of the plurality of outputs. In some cases, the plurality of memory devices is a plurality of flash memory devices. In one or more cases, the configuration circuit includes a cross-bar switch having a plurality of switches controlled by the programmable control circuit. In some such cases, the programmable control circuit includes a number of writable register values that each correspond to at least one of the plurality of switches.

In some instances of the aforementioned embodiments, the input is a host data bus input/output and the plurality of memory devices includes a first memory device and a second memory device. The first memory device includes a first data bus input/output, the second memory device includes a second data bus input/output, the plurality of outputs includes a first data bus communicably coupled to the first data bus input/output, and a second data bus communicably coupled to the second data bus input/output. The programmable control circuit selectably couples the host data bus input/output to one or both of the first data bus and the second data bus.

In various instances, the input is a host chip enable input, and the plurality of memory devices includes a first memory device and a second memory device. The first memory device includes a first chip enable input, and the second memory device includes a second chip enable input. The plurality of outputs includes a first chip enable output communicably coupled to the first chip enable input and a second data bus output communicably coupled to the second chip enable input. The programmable control circuit selectably couples the host chip enable input to one or both of the first chip enable output and the second chip enable output.

In one or more instances, the input is a host command/response input, and the plurality of memory devices includes a first memory device and a second memory device. The first memory device includes a first command/response input, and the second memory device includes a second command/response input. The plurality of outputs includes a first command/response output communicably coupled to the first command/response input, and a second command/response output communicably coupled to the second command/response input. The programmable control circuit selectably couples the host command/response input to one or both of the first command/response output and the second command/response output.

In some instances of the aforementioned embodiments, each of the plurality of memory devices is implemented on a separate semiconductor die. In various instances of the aforementioned embodiments, the configuration circuit is implemented on a semiconductor die that is separate a semiconductor die on which one or more of the memory devices is implemented. In one or more instances of the aforementioned embodiments, each of the plurality of memory devices is implemented in a separate semiconductor package. In particular instances of the aforementioned embodiments, the configuration circuit is implemented in a semiconductor package that is separate a semiconductor package in which one or more of the memory devices is packaged.

Other embodiments provide methods for configuring a switchable memory. Such methods include providing a memory system having a plurality of memory devices and a configuration circuit. The configuration circuit has at least one input, a plurality of outputs, and a programmable control circuit. The plurality of outputs are communicably coupled to the plurality of memory devices. The methods further include programming the programmable control circuit to selectably couple the input to at least one of the plurality of outputs. In some cases, the configuration circuit includes a cross-bar switch having a plurality of switches controlled by the programmable control circuit. In some such cases, the programmable control circuit includes a number of writable register values that each correspond to at least one of the plurality of switches, and programming the programmable control circuit includes writing one or more of the writable register values.

Yet other embodiments provide circuits having a plurality of memory circuits that each is accessible via a memory circuit data bus, and a configuration circuit. The configuration circuit has at least one host data bus input/output, a plurality of configuration data bus input/outputs, and a programmable control circuit. The plurality of configuration data bus input/outputs are communicably coupled to the plurality of memory circuit data bus. The programmable control circuit is operable to selectably couple the host data bus input/output to at least one of the plurality of configuration data bus input/outputs.

This summary provides only a general outline of some embodiments that are possible within the scope of the claims. Many other objects, features, advantages and other embodiments will become more fully apparent from the following detailed description, the appended claims and the accompanying drawings.

### BRIEF DESCRIPTION OF THE DRAWINGS

A further understanding of the various embodiments may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts an example flash memory system including four flash memory devices arranged on two lanes;

FIG. 2 depicts a computing system including a memory system exhibiting a switchable memory configuration in accordance with one or more embodiments;

FIG. 3a depicts a memory system including a switchable memory configuration in accordance with some embodiments;

FIG. 3b shows a cross-bar switch operable to connect selected chip enables from a memory controller to a variety of memory devices that may be used in relation to some embodiments;

FIG. 3c shows a cross-bar switch operable to connect selected command/response signals from a memory controller to a variety of memory devices that may be used in relation to some embodiments;

FIG. 3d shows a cross-bar switch operable to connect selected data buses from a memory controller to a variety of memory devices that may be used in relation to some embodiments;

FIGS. 4a-4f depict examples of ways that the memory system of FIGS. 3a-3d may be configured in accordance with various embodiments; and

FIG. 5 is a flow diagram depicting a method in accordance with one or more embodiments for configuring a switchable memory.

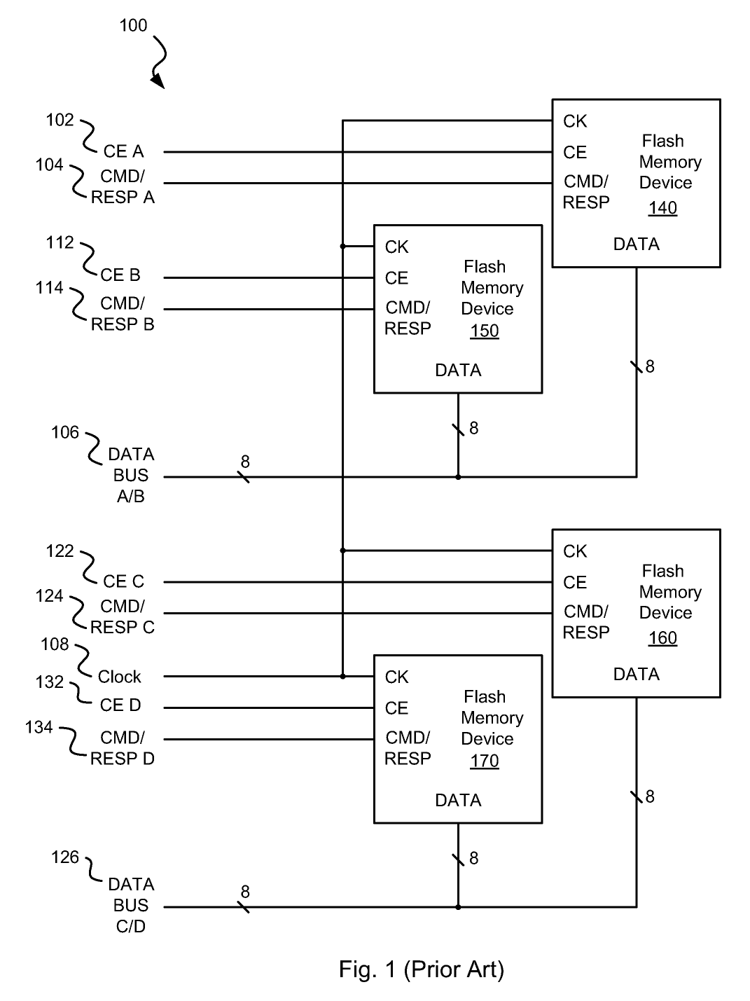

### DETAILED DESCRIPTION

The present disclosure is related to systems and methods for configurable memory systems, and more particularly to systems and methods that allow for matching a memory system to one or more system requirements.

Different storage applications demand different combinations of bandwidth, IOPS and pin count. For example, a large enterprise server may support a very large number of read requests with each read request requiring only a small bandwidth. Such an application is benefited by a large number of IOPS and is not negatively impacted where the overall bandwidth is relatively low. In contrast, a head end of a video delivery system receives a relatively small number of requests with each of the requests demanding a relatively large bandwidth. Such an application demands a relatively high bandwidth, while only requiring a modest number of IOPS. Various embodiments disclosed herein provide systems and methods that allow for programmable reconfiguration of the lanes of a flash memory module to allow selection of a particular combination of bandwidth and number of IOPS. In some instances of the aforementioned embodiments, the programmable reconfiguration is implemented using a cross-bar switch attached to a number of lanes with the cross bar switch being controlled by programmable registers.

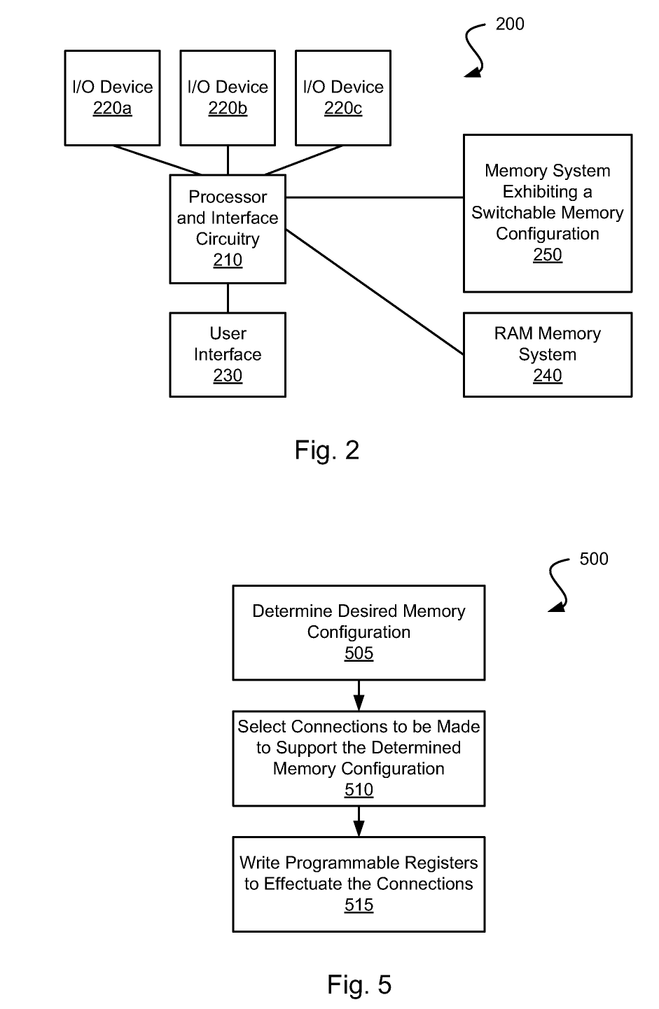

Turning to FIG. 2, a computing system 200 including a memory system 250 exhibiting a switchable memory configuration is depicted in accordance with one or more embodiments. In addition to memory system 250, computing system 200 includes a processor with interface circuitry 210 that is communicably coupled to one or more input/output devices 220 and a user interface 230. In addition, processor 210 is communicably coupled to a random access memory 240. In one particular implementation, computing system 200 is a personal computer and input/output devices 220 may include, but are not limited to, a keyboard, a mouse, a touch screen or the like. In such a case, user interface 230 may be a display. Random access memory 240 may hold a variety of instructions that are executable by processor 210 to cause particular actions to take place.

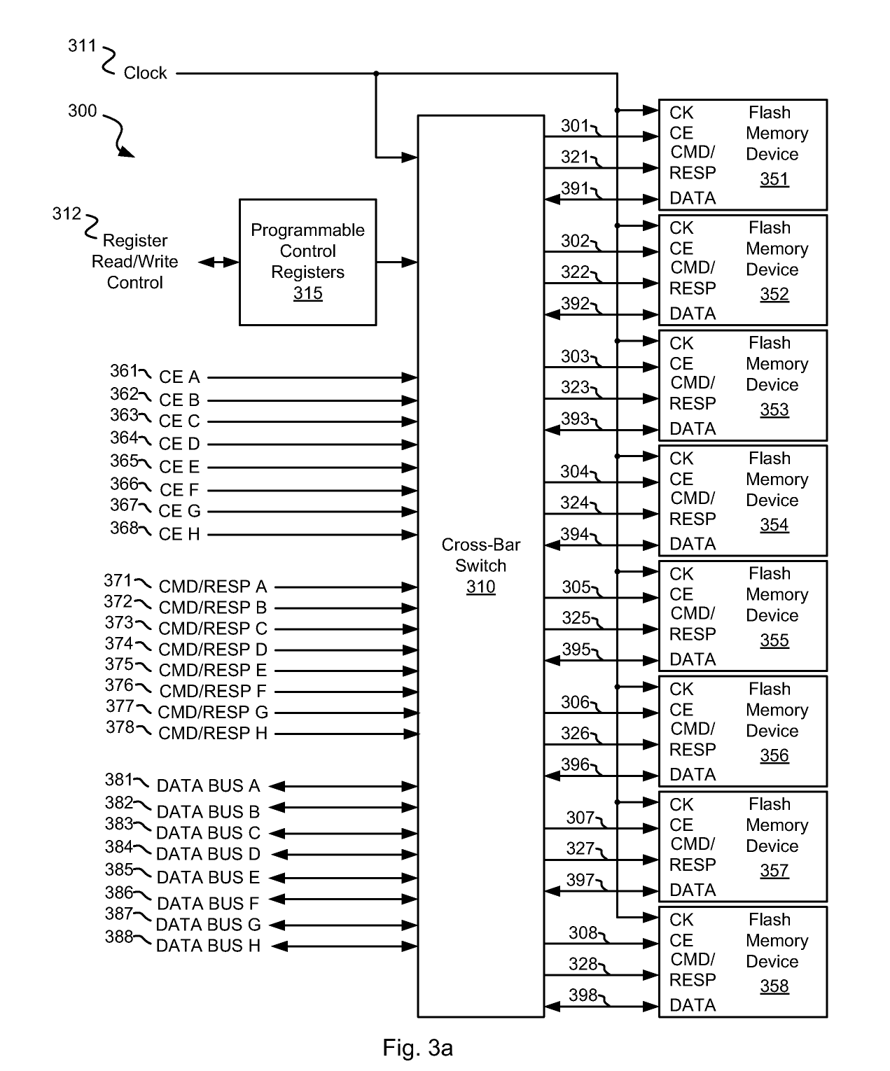

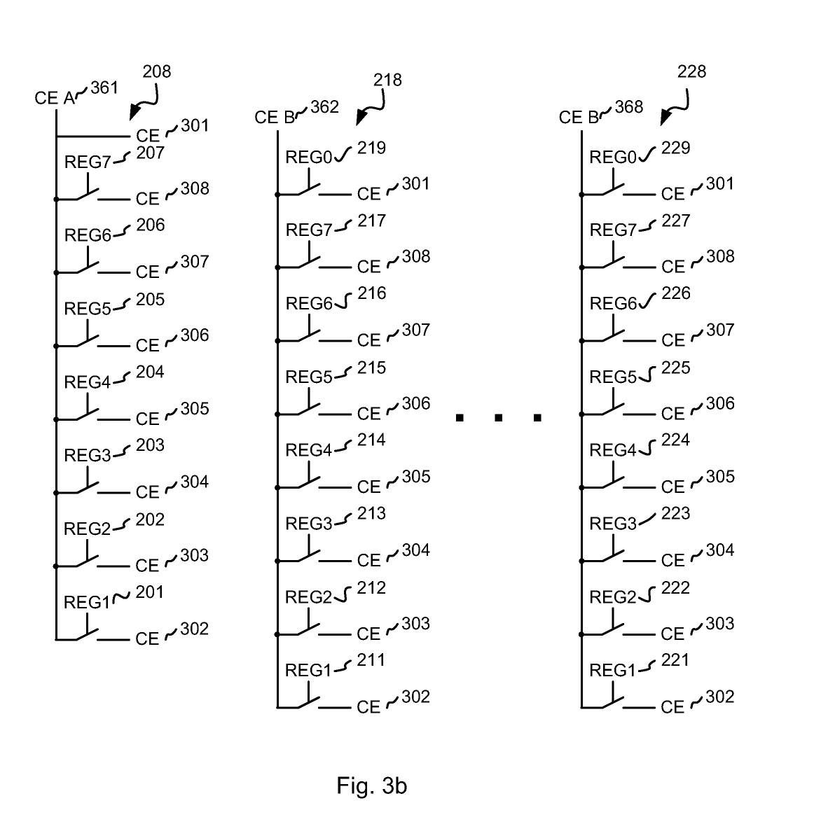

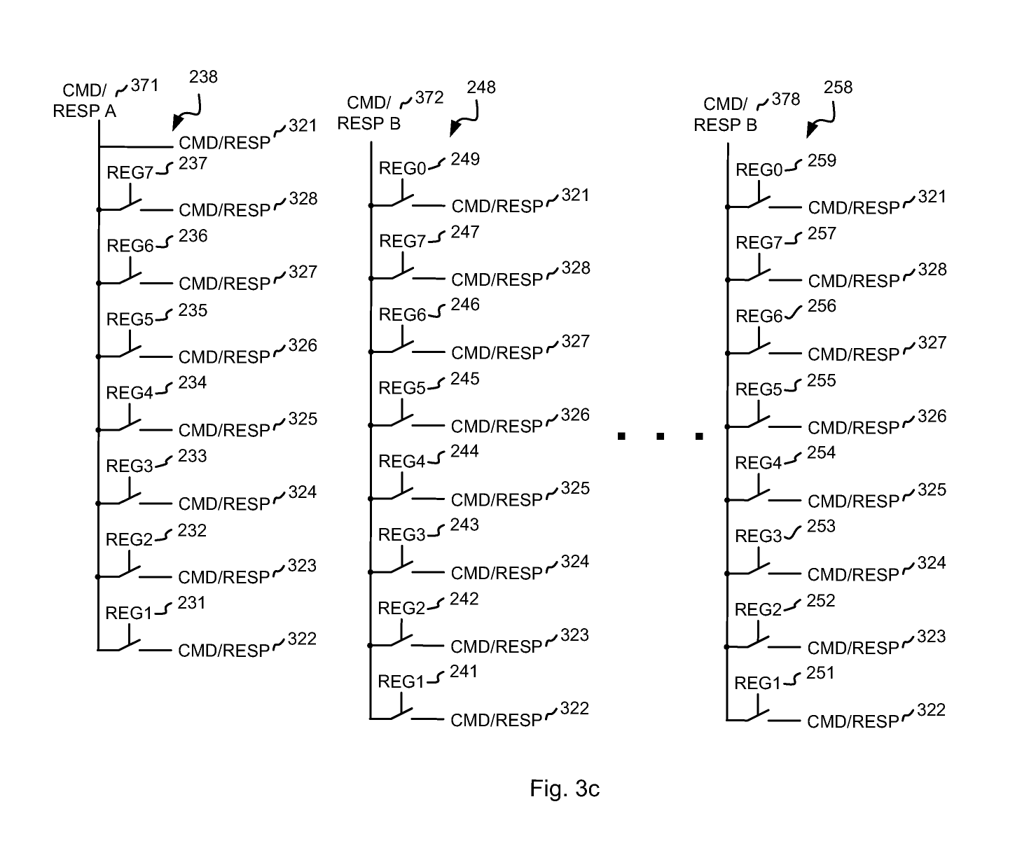

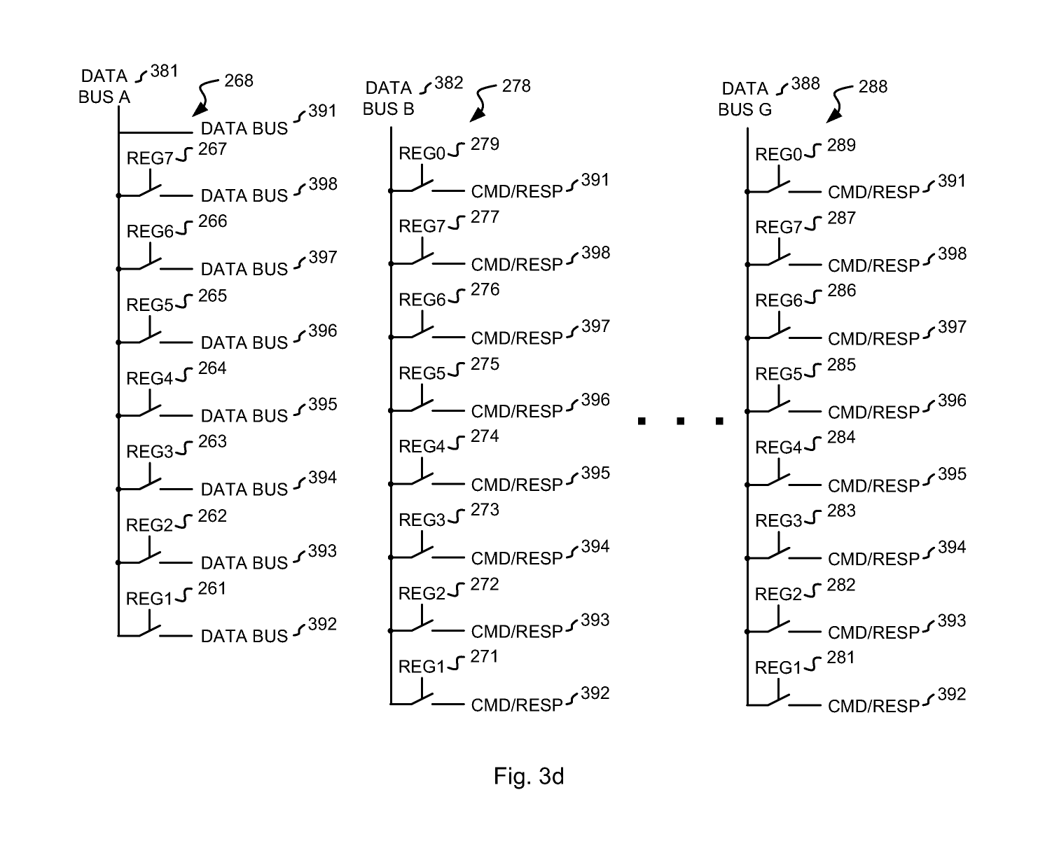

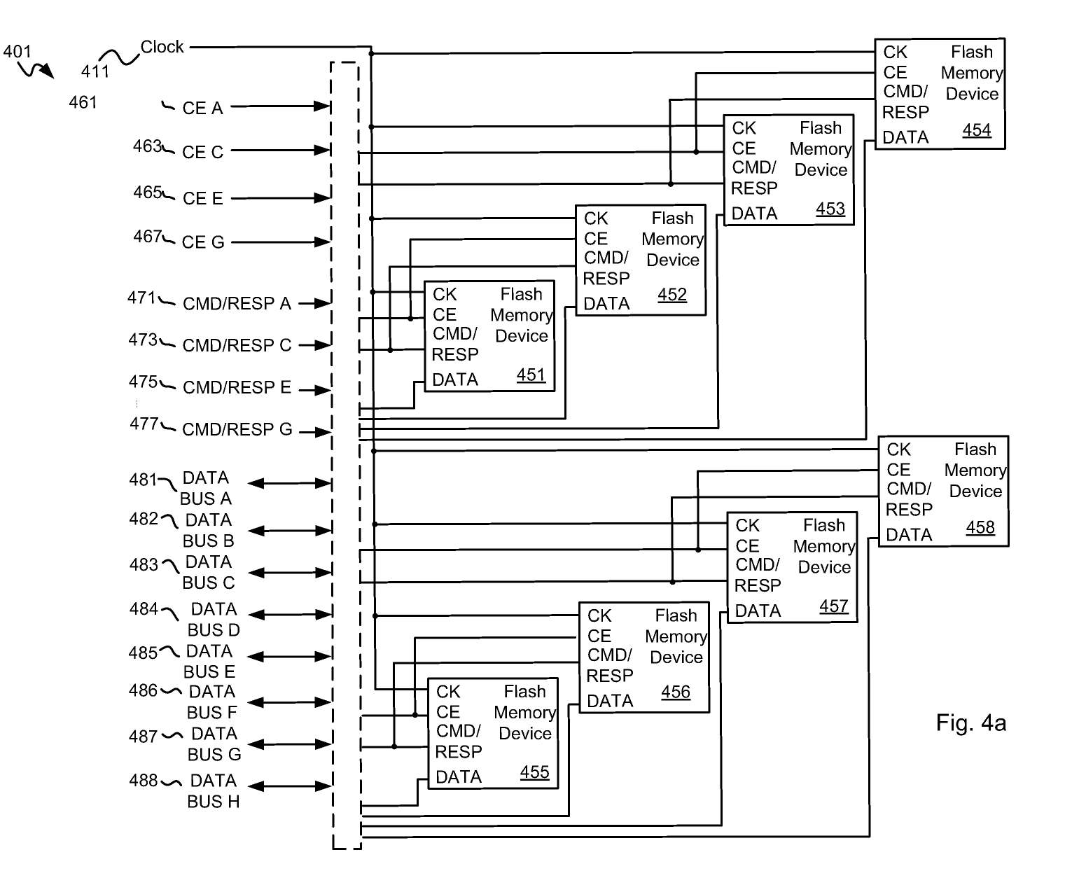

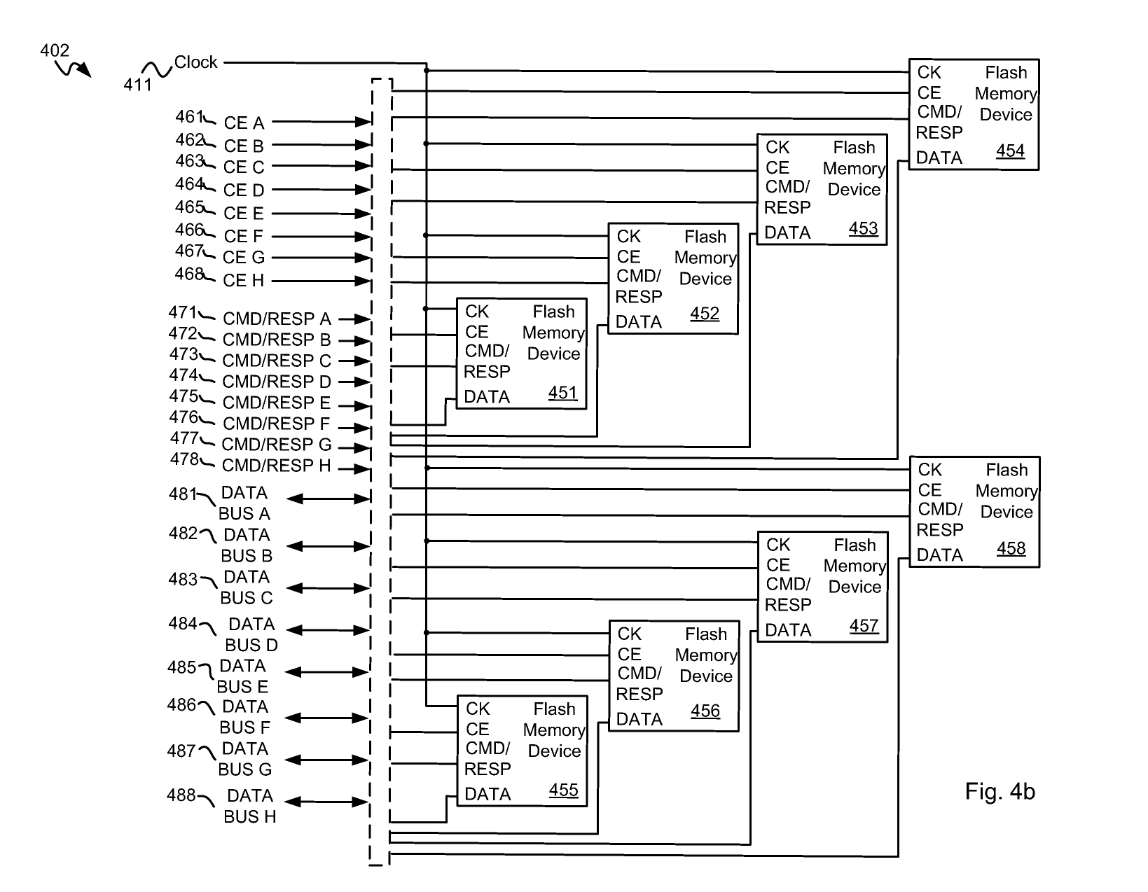

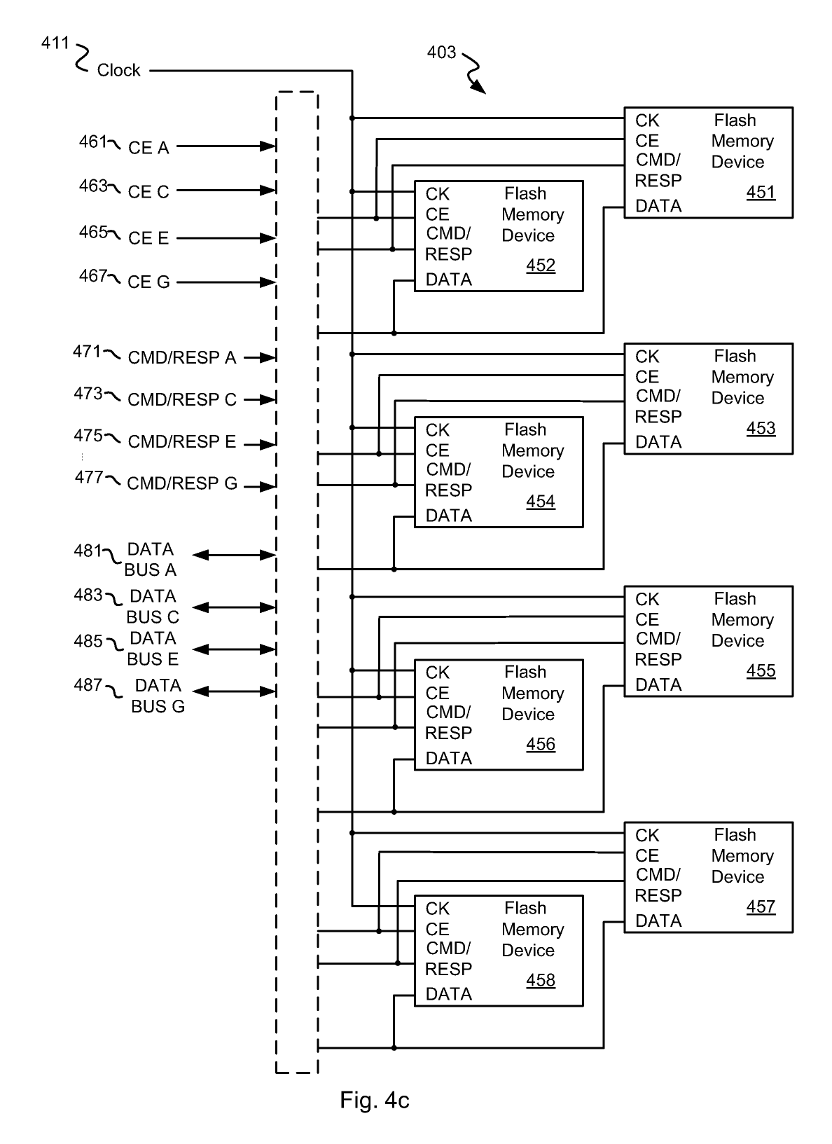

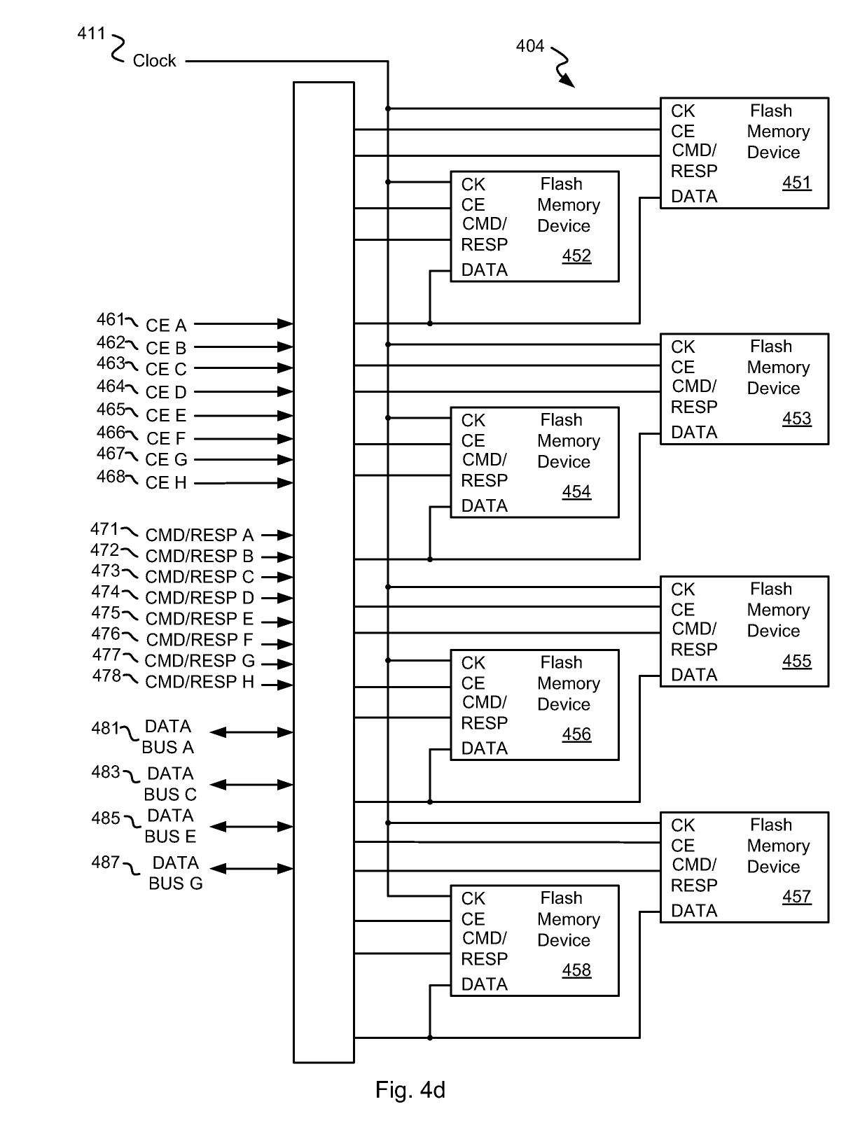

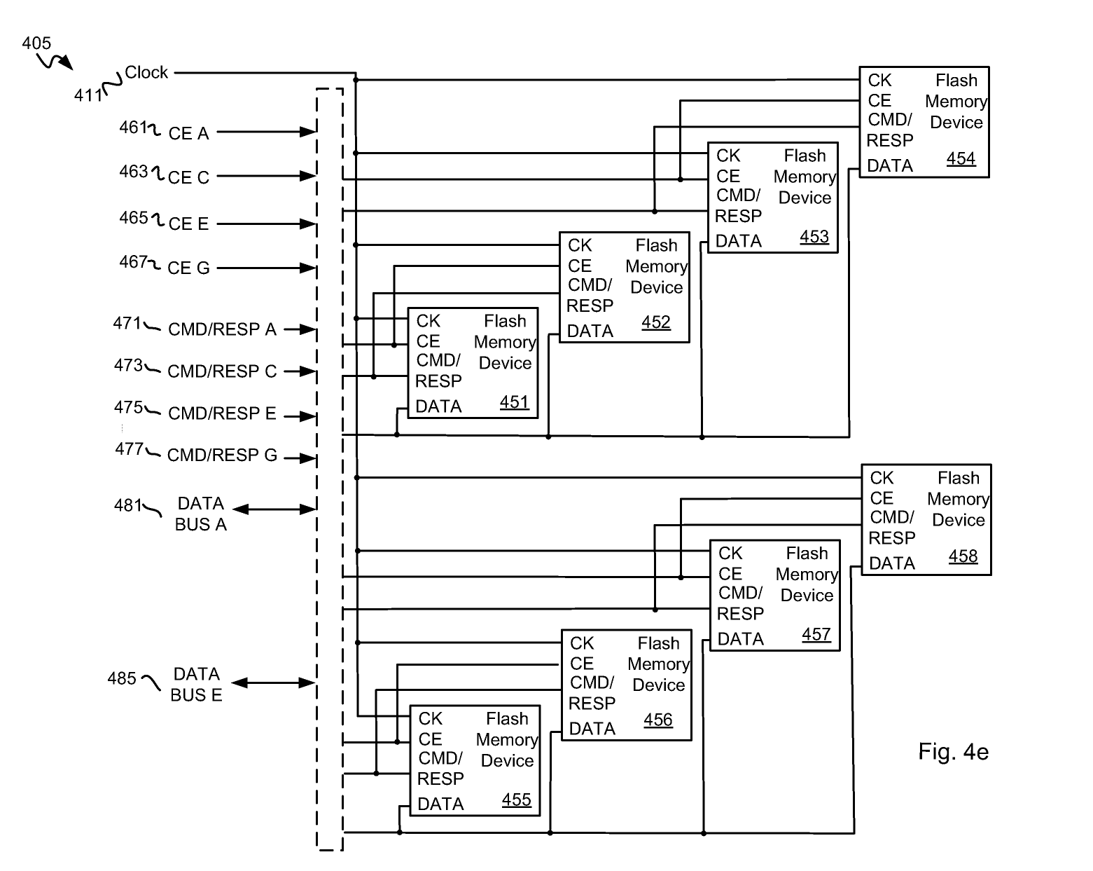

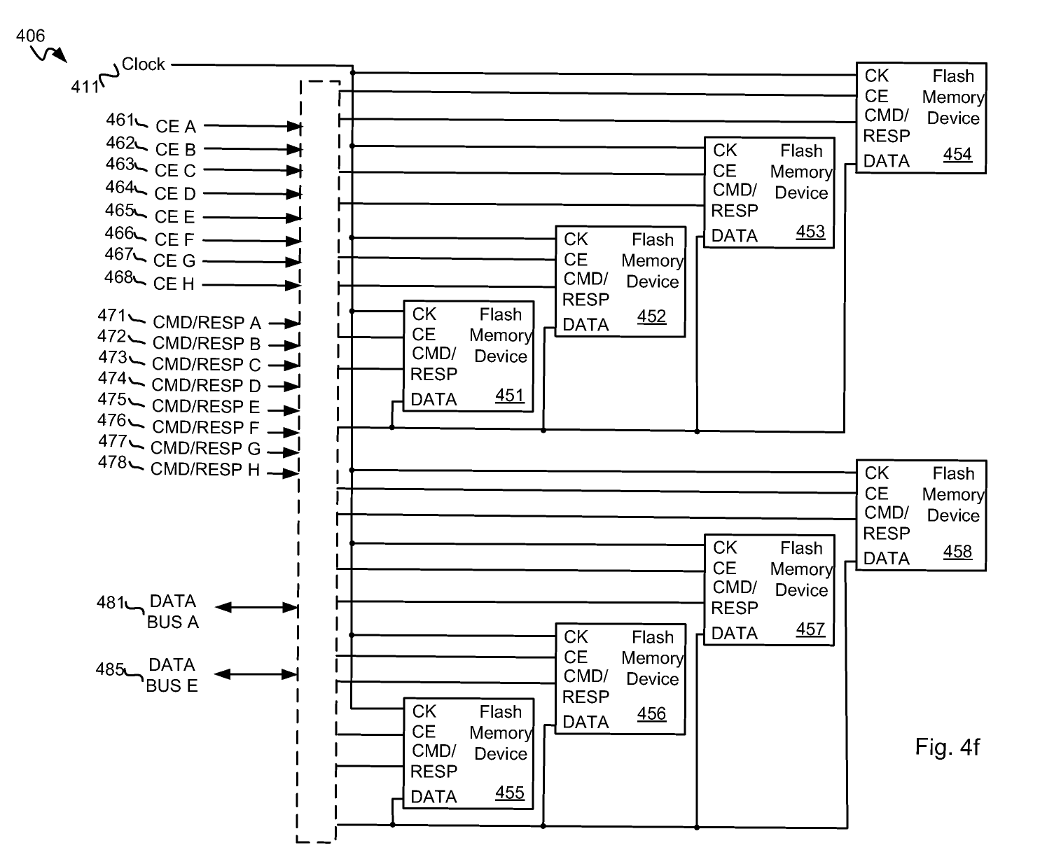

Memory system 250 exhibits a switchable memory configuration. The switchable memory configuration may be implemented similar to that discussed below in relation to FIGS. 3a-3f. Memory system 250 may be configured by processor 210 through writing one or more configuration registers. Among other configurations for memory systems, memory system 250 may be configured similar to that discussed in relation to FIGS. 4a-4f above.

Turning to FIG. 3a, a memory system 300 including a switchable memory configuration is shown in accordance with some embodiments. As shown, memory system 300 includes eight flash memory devices 351, 352, 353, 354, 355, 356, 357, 358 all communicably coupled to a cross-bar switch 310. Each of flash memory devices 351, 352, 353, 354, 355, 356, 357, 358 is accessible via an interface that includes a clock input (CK), a chip enable input (CE), a command/response input (CMD/RESP), and a bidirectional data bus (DATA). The assertion level of the signal applied to the command/response input controls whether data is written to the respective memory device or read from the respective memory device. A clock input 311 is connected to the clock input of each of flash memory devices 351, 352, 353, 354, 355, 356, 357, 358. It should be noted that other memory devices with different interfaces may be used in relation to different embodiments. As used herein, the phrase “communicably coupled” is used in its broadest sense to mean a coupling whereby information may be passed between two devices. In some cases, the communicable coupling is an electrical coupling. As used herein, the phrase “electrical coupling” or “electrically coupled” are used in their broadest sense to mean a coupling whereby an electrical signal may be passed between two devices. Based upon the disclosure provided herein, one of ordinary skill in the art will recognize a variety of electrical couplings and/or communicable couplings that may be used in relation to various embodiments. It should be noted that while FIG. 3a depicts eight flash memory devices that another number of memory devices may be used in implementing memory system 300. Further, it should be noted that while FIG. 3a depicts flash memory devices, that other types of memory devices may be used in implementing memory system 300.

In particular, flash memory device 351 is communicably coupled to cross-bar switch 310 via a chip enable signal 301, a command/response signal 321, and a data bus 391. Data bus 391 has the same width as the data bus supported by flash memory device 351. Flash memory device 352 is communicably coupled to cross-bar switch 310 via a chip enable signal 302, a command/response signal 322, and a data bus 392. Data bus 392 has the same width as the data bus supported by flash memory device 352. Flash memory device 353 is communicably coupled to cross-bar switch 310 via a chip enable signal 303, a command/response signal 323, and a data bus 393. Data bus 393 has the same width as the data bus supported by flash memory device 353. Flash memory device 354 is communicably coupled to cross-bar switch 310 via a chip enable signal 304, a command/response signal 324, and a data bus 394. Data bus 394 has the same width as the data bus supported by flash memory device 354. Flash memory device 355 is communicably coupled to cross-bar switch 310 via a chip enable signal 305, a command/response signal 325, and a data bus 395. Data bus 395 has the same width as the data bus supported by flash memory device 355. Flash memory device 356 is communicably coupled to cross-bar switch 310 via a chip enable signal 306, a command/response signal 326, and a data bus 396. Data bus 396 has the same width as the data bus supported by flash memory device 356. Flash memory device 357 is communicably coupled to cross-bar switch 310 via a chip enable signal 307, a command/response signal 327, and a data bus 397. Data bus 397 has the same width as the data bus supported by flash memory device 357. Flash memory device 358 is communicably coupled to cross-bar switch 310 via a chip enable signal 308, a command/response signal 328, and a data bus 398. Data bus 398 has the same width as the data bus supported by flash memory device 358.

Operation of cross-bar switch 310 is governed by register values programmed into programmable control registers 315. Together, cross-bar switch 310 and programmable control registers 315 form a configuration circuit. As used herein, the phrase “configuration circuit” is used in its broadest sense to mean any circuit that may be used to achieve two or more different configurations. Programmable control registers 315 may be written and read via a register read/write control interface 312. Register read/write control interface 312 may be any register access interface known in the art. Programmable control registers 315 may include a number of accessible registers. The registers may include a number of registers designed to control switches in cross-bar switch 310.

Cross-bar switch 310 includes a number of switches capable of cross connecting the various inputs/outputs to other inputs/outputs. By doing this, cross-bar switch 310 is capable of configuring flash memory devices 351, 352, 353, 354, 355, 356, 357, 358 into a desired configuration. In this case, the inputs to cross-bar switch 310 includes a number of chip enable inputs 361, 362, 363, 364, 365, 366, 367, 368; a number of command/response inputs 371, 372, 373, 374, 375, 376, 377, 378; and a number of bidirectional data buses 381, 382, 383, 384, 385, 386, 387, 388. In some embodiments, the number of chip enable inputs, command/response inputs, and bidirectional data buses are equal to the number of memory devices supported by cross-bar switch 310. As such, with a sufficient number of register inputs from programmable control registers 315 and corresponding switches, cross-bar switch 310 is capable of allowing any configuration of flash memory devices 351, 352, 353, 354, 355, 356, 357, 358 from individual control with all devices operating in parallel to unified control with all devices operating in serial. Based upon the disclosure provided herein, one of ordinary skill in the art will recognize a myriad of configurations that are possible in accordance with different embodiments.

Some embodiments provide for implementing configurable memories using discrete devices that may be implemented on either different semiconductor die and/or different semiconductor packages. For example, in some instances each of the flash memory devices is implemented on a separate semiconductor die. As another example, in various instances the configuration circuit is implemented on a semiconductor die that is separate a semiconductor die on which one or more of the memory devices is implemented. As yet another example, in one or more instances, each of the flash memory devices is implemented in a separate semiconductor package. As yet a further example, in some instances, the configuration circuit is implemented in a semiconductor package that is separate from a semiconductor package in which one or more of the memory devices is packaged.

Turning to FIG. 3b, an example cross-bar switches operable to connect selected chip enables from a memory controller to a variety of memory devices is shown that may be used in relation to some embodiments. A cross-bar switch 208 is capable of connecting chip enable 361 to one or more of chip enable inputs 301, 302, 303, 304, 305, 306, 307, 308. Control of cross-bar switch 208 is done by writing register values 201, 202, 203, 204, 205, 206, 207 that each control whether a respective corresponding switch is open or closed. In one particular embodiment, switches are closed when a logic ‘1’ is written to the corresponding register value, and switches are open when a logic ‘0’ is written to the corresponding register value. A cross-bar switch 218 is capable of connecting chip enable 362 to one or more of chip enable inputs 301, 302, 303, 304, 305, 306, 307, 308. Control of cross-bar switch 218 is done by writing register values 211, 212, 213, 214, 215, 216, 217, 219 that each control whether a respective corresponding switch is open or closed. A cross-bar switch 228 is capable of connecting chip enable 368 to one or more of chip enable inputs 301, 302, 303, 304, 305, 306, 307, 308. Control of cross-bar switch 228 is done by writing register values 221, 222, 223, 224, 225, 226, 227, 229 that each control whether a respective corresponding switch is open or closed. While not shown, similar cross-bar switches operate to communicably couple chip enables 363, 364, 365, 366, 367 to one or more chip enable inputs 301, 302, 303, 304, 305, 306, 307, 308.

Turning to FIG. 3c, an example cross-bar switches operable to connect selected command/response signals from a memory controller to a variety of memory devices is shown that may be used in relation to some embodiments. A cross-bar switch 238 is capable of connecting command/response 371 to one or more of command/response inputs 371, 372, 373, 374, 375, 376, 377, 378. Control of cross-bar switch 238 is done by writing register values 231, 232, 233, 234, 235, 236, 237 that each control whether a respective corresponding switch is open or closed. In one particular embodiment, switches are closed when a logic ‘1’ is written to the corresponding register value, and switches are open when a logic ‘0’ is written to the corresponding register value. A cross-bar switch 248 is capable of connecting command/response 372 to one or more of command/response inputs 371, 372, 373, 374, 375, 376, 377, 378. Control of cross-bar switch 248 is done by writing register values 241, 242, 243, 244, 245, 246, 247, 249 that each control whether a respective corresponding switch is open or closed. A cross-bar switch 258 is capable of connecting chip enable 378 to one or more of command/response inputs 371, 372, 373, 374, 375, 376, 377, 378. Control of cross-bar switch 258 is done by writing register values 251, 252, 253, 254, 255, 256, 257, 259 that each control whether a respective corresponding switch is open or closed. While not shown, similar cross-bar switches operate to communicably couple command/response signals 373, 374, 375, 376, 377 to one or more command/response inputs 371, 372, 373, 374, 375, 376, 377, 378.

Turning to FIG. 3d, an example cross-bar switches operable to connect selected data buses from a memory controller to a variety of memory devices is shown that may be used in relation to some embodiments. A cross-bar switch 268 is capable of connecting data bus 381 to one or more of data buses 391, 392, 393, 394, 395, 396, 397, 398. Control of cross-bar switch 238 is done by writing register values 261, 262, 263, 264, 265, 266, 267 that each control whether a respective corresponding switch is open or closed. In one particular embodiment, switches are closed when a logic ‘1’ is written to the corresponding register value, and switches are open when a logic ‘0’ is written to the corresponding register value. A cross-bar switch 278 is capable of connecting data bus 382 to one or more of data buses 391, 392, 393, 394, 395, 396, 397, 398. Control of cross-bar switch 278 is done by writing register values 271, 272, 273, 274, 275, 276, 277, 279 that each control whether a respective corresponding switch is open or closed. A cross-bar switch 288 is capable of connecting chip enable 388 to one or more of data buses 391, 392, 393, 394, 395, 396, 397, 398. Control of cross-bar switch 288 is done by writing register values 281, 282, 283, 284, 285, 286, 287, 289 that each control whether a respective corresponding switch is open or closed. While not shown, similar cross-bar switches operate to communicably couple data buses 383, 384, 385, 386, 387 to one or more data buses 391, 392, 393, 394, 395, 396, 397, 398.

FIGS. 4a-4f depict examples of ways that the memory system 300 may be configured depending upon the values written to program control registers 315 in accordance with various embodiments. Turning to FIG. 4a, a memory system 401 is depicted that includes a clock input 411 that is distributed to each of eight flash memory devices 451, 452, 453, 454, 455, 456, 457, 458. The switch selection registers discussed above in relation to FIG. 3b are set such that chip enable 461 is electrically coupled to the chip enable input of both flash memory device 453 and flash memory device 454; chip enable 463 is electrically coupled to the chip enable input of both flash memory device 451 and flash memory device 452; chip enable 465 is electrically coupled to the chip enable input of both flash memory device 457 and flash memory device 458; and chip enable 467 is electrically coupled to the chip enable input of both flash memory device 455 and flash memory device 456. The switch selection registers discussed above in relation to FIG. 3c are set such that command/response signal 471 is electrically coupled to the command/response input of both flash memory device 453 and flash memory device 454; command/response signal 473 is electrically coupled to the command/response input of both flash memory device 451 and flash memory device 452; command/response signal 475 is electrically coupled to the command/response input of both flash memory device 457 and flash memory device 458; and command/response signal 477 is electrically coupled to the command/response input of both flash memory device 455 and flash memory device 456. The switch selection registers discussed above in relation to FIG. 3d are set such that data bus 481 is electrically coupled to the data bus of flash memory device 454; data bus 482 is electrically coupled to the data bus of flash memory device 453; data bus 483 is electrically coupled to the data bus of flash memory device 452; data bus 484 is electrically coupled to the data bus of flash memory device 451; data bus 485 is electrically coupled to the data bus of flash memory device 458; data bus 486 is electrically coupled to the data bus of flash memory device 457; data bus 487 is electrically coupled to the data bus of flash memory device 456; and data bus 488 is electrically coupled to the data bus of flash memory device 455.

In this configuration, flash memory devices 451, 452, 453, 454, 455, 456, 457, 458 are controlled in groups of two where each group of two flash memory devices are controlled by common chip enable and command/response signals. The data buses each operate separately such that each group of two flash memory devices supports a combined data bus that is twice the width as the data bus support by one of the respective memory devices 451, 452, 453, 454, 455, 456, 457, 458. As an example, where each flash memory device has an eight bit data bus, the configuration of memory system 401 supports four sixteen bit data buses (e.g., [1] data buses 481, 482; [2] data buses 483, 484; [3] data buses 485, 486; and [4] data buses 487, 488) operating in parallel. Following the example, where each of flash memory devices 451, 452, 453, 454, 455, 456, 457, 458 requires one hundred, fifty microseconds to access a 4K block of data, is capable of supporting 27 MHz of bandwidth and 6.66K IOPS, the configuration of memory system 401 supports 216 MHz of bandwidth (i.e., 27 MHz times eight data buses) and 26.6K IOPS (i.e., 6.66 IOPS times four independently accessible groups of memory devices).

Turning to FIG. 4b, a memory system 402 is depicted that includes a clock input 411 that is distributed to each of eight flash memory devices 451, 452, 453, 454, 455, 456, 457, 458. The switch selection registers discussed above in relation to FIG. 3b are set such that chip enable 461 is electrically coupled to the chip enable input of flash memory device 454; chip enable 462 is electrically coupled to the chip enable input of flash memory device 453; chip enable 463 is electrically coupled to the chip enable input of flash memory device 452; chip enable 464 is electrically coupled to the chip enable input of flash memory device 451; chip enable 465 is electrically coupled to the chip enable input of flash memory device 458; chip enable 466 is electrically coupled to the chip enable input of flash memory device 457; chip enable 467 is electrically coupled to the chip enable input of flash memory device 456; and chip enable 468 is electrically coupled to the chip enable input of flash memory device 455. The switch selection registers discussed above in relation to FIG. 3c are set such that command/response signal 471 is electrically coupled to the command/response input of flash memory device 454; command/response signal 472 is electrically coupled to the command/response input of flash memory device 453; command/response signal 473 is electrically coupled to the command/response input of flash memory device 452; command/response signal 474 is electrically coupled to the command/response input of flash memory device 451; command/response signal 475 is electrically coupled to the command/response input of flash memory device 458; command/response signal 476 is electrically coupled to the command/response input of flash memory device 457; command/response signal 477 is electrically coupled to the command/response input of flash memory device 456; and command/response signal 478 is electrically coupled to the command/response input of flash memory device 455. The switch selection registers discussed above in relation to FIG. 3d are set such that data bus 481 is electrically coupled to the data bus of flash memory device 454; data bus 482 is electrically coupled to the data bus of flash memory device 453; data bus 483 is electrically coupled to the data bus of flash memory device 452; data bus 484 is electrically coupled to the data bus of flash memory device 451; data bus 485 is electrically coupled to the data bus of flash memory device 458; data bus 486 is electrically coupled to the data bus of flash memory device 457; data bus 487 is electrically coupled to the data bus of flash memory device 456; and data bus 488 is electrically coupled to the data bus of flash memory device 455.

In this configuration, flash memory devices 451, 452, 453, 454, 455, 456, 457, 458 are each controlled individually with each of the memory devices receiving independent chip enable and command/response signals. In addition, the data buses each operate separately such that there are eight data buses operating in parallel. As an example, where each of flash memory devices 451, 452, 453, 454, 455, 456, 457, 45 has an eight bit data bus, requires one hundred, fifty microseconds to access a 4K block of data, is capable of supporting 27 MHz of bandwidth and 6.66K IOPS, the configuration of memory system 402 supports 216 MHz of bandwidth (i.e., 27 MHz times eight data buses) and 53.3K IOPS (i.e., 6.66 IOPS times eight independently accessible memory devices).

Turning to FIG. 4c, a memory system 403 is depicted that includes a clock input 411 that is distributed to each of eight flash memory devices 451, 452, 453, 454, 455, 456, 457, 458. The switch selection registers discussed above in relation to FIG. 3b are set such that chip enable 461 is electrically coupled to the chip enable input of both flash memory device 453 and flash memory device 454; chip enable 463 is electrically coupled to the chip enable input of both flash memory device 451 and flash memory device 452; chip enable 465 is electrically coupled to the chip enable input of both flash memory device 457 and flash memory device 458; and chip enable 467 is electrically coupled to the chip enable input of both flash memory device 455 and flash memory device 456. The switch selection registers discussed above in relation to FIG. 3c are set such that command/response signal 471 is electrically coupled to the command/response input of both flash memory device 453 and flash memory device 454; command/response signal 473 is electrically coupled to the command/response input of both flash memory device 451 and flash memory device 452; command/response signal 475 is electrically coupled to the command/response input of both flash memory device 457 and flash memory device 458; and command/response signal 477 is electrically coupled to the command/response input of both flash memory device 455 and flash memory device 456. The switch selection registers discussed above in relation to FIG. 3d are set such that data bus 481 is electrically coupled to both the data bus of flash memory device 454 and the data bus of flash memory device 453; data bus 483 is electrically coupled to both the data bus of flash memory device 452 and the data bus of flash memory device 451; data bus 485 is electrically coupled to both the data bus of flash memory device 458 and the data bus of flash memory device 457; and data bus 487 is electrically coupled to both the data bus of flash memory device 456 and the data bus of flash memory device 455.

In this configuration, flash memory devices 451, 452, 453, 454, 455, 456, 457, 458 are controlled in groups of two where each group of two flash memory devices are controlled by common chip enable and command/response signals. The data buses also operate in groups of two such that two flash memory devices are coupled to a common data bus that is the width of the data bus supported by one of the respective memory devices 451, 452, 453, 454, 455, 456, 457, 458. As an example, where each flash memory device has an eight bit data bus, the configuration of memory system 403 supports four eight bit data buses operating in parallel. Following the example, where each of flash memory devices 451, 452, 453, 454, 455, 456, 457, 458 requires one hundred, fifty microseconds to access a 4K block of data, is capable of supporting 27 MHz of bandwidth and 6.66K IOPS, the configuration of memory system 403 supports 108 MHz of bandwidth (i.e., 27 MHz times four data buses) and 26.6K IOPS (i.e., 6.66 IOPS times four independently accessible groups of memory devices).

Turning to FIG. 4d, a memory system 404 is depicted that includes a clock input 411 that is distributed to each of eight flash memory devices 451, 452, 453, 454, 455, 456, 457, 458. The switch selection registers discussed above in relation to FIG. 3b are set such that chip enable 461 is electrically coupled to the chip enable input of flash memory device 454; chip enable 462 is electrically coupled to the chip enable input of flash memory device 453; chip enable 463 is electrically coupled to the chip enable input of flash memory device 452; chip enable 464 is electrically coupled to the chip enable input of flash memory device 451; chip enable 465 is electrically coupled to the chip enable input of flash memory device 458; chip enable 466 is electrically coupled to the chip enable input of flash memory device 457; chip enable 467 is electrically coupled to the chip enable input of flash memory device 456; and chip enable 468 is electrically coupled to the chip enable input of flash memory device 455. The switch selection registers discussed above in relation to FIG. 3c are set such that command/response signal 471 is electrically coupled to the command/response input of flash memory device 454; command/response signal 472 is electrically coupled to the command/response input of flash memory device 453; command/response signal 473 is electrically coupled to the command/response input of flash memory device 452; command/response signal 474 is electrically coupled to the command/response input of flash memory device 451; command/response signal 475 is electrically coupled to the command/response input of flash memory device 458; command/response signal 476 is electrically coupled to the command/response input of flash memory device 457; command/response signal 477 is electrically coupled to the command/response input of flash memory device 456; and command/response signal 478 is electrically coupled to the command/response input of flash memory device 455. The switch selection registers discussed above in relation to FIG. 3d are set such that data bus 481 is electrically coupled to both the data bus of flash memory device 454 and the data bus of flash memory device 453; data bus 483 is electrically coupled to both the data bus of flash memory device 452 and the data bus of flash memory device 451; data bus 485 is electrically coupled to both the data bus of flash memory device 458 and the data bus of flash memory device 457; and data bus 487 is electrically coupled to both the data bus of flash memory device 456 and the data bus of flash memory device 455.

In this configuration, flash memory devices 451, 452, 453, 454, 455, 456, 457, 458 are each controlled individually with each of the memory devices receiving independent chip enable and command/response signals. The data buses operate in groups of two such that two flash memory devices are coupled to a common data bus that is the width of the data bus supported by one of the respective memory devices 451, 452, 453, 454, 455, 456, 457, 458. As an example, where each of flash memory devices 451, 452, 453, 454, 455, 456, 457, 458 has an eight bit data bus, requires one hundred, fifty microseconds to access a 4K block of data, is capable of supporting 27 MHz of bandwidth and 6.66K IOPS, the configuration of memory system 404 supports 108 MHz of bandwidth (i.e., 27 MHz times four data buses) and 53.3K IOPS (i.e., 6.66 IOPS times eight independently accessible memory devices).

Turning to FIG. 4e, a memory system 405 is depicted that includes a clock input 411 that is distributed to each of eight flash memory devices 451, 452, 453, 454, 455, 456, 457, 458. The switch selection registers discussed above in relation to FIG. 3b are set such that chip enable 461 is electrically coupled to the chip enable input of both flash memory device 453 and flash memory device 454; chip enable 463 is electrically coupled to the chip enable input of both flash memory device 451 and flash memory device 452; chip enable 465 is electrically coupled to the chip enable input of both flash memory device 457 and flash memory device 458; and chip enable 467 is electrically coupled to the chip enable input of both flash memory device 455 and flash memory device 456. The switch selection registers discussed above in relation to FIG. 3c are set such that command/response signal 471 is electrically coupled to the command/response input of both flash memory device 453 and flash memory device 454; command/response signal 473 is electrically coupled to the command/response input of both flash memory device 451 and flash memory device 452; command/response signal 475 is electrically coupled to the command/response input of both flash memory device 457 and flash memory device 458; and command/response signal 477 is electrically coupled to the command/response input of both flash memory device 455 and flash memory device 456. The switch selection registers discussed above in relation to FIG. 3d are set such that data bus 481 is electrically coupled to all four of the data buses of flash memory device 454, flash memory device 453, flash memory device 452, and flash memory device 451; and data bus 485 is electrically coupled to all four of the data buses of flash memory device 458, flash memory device 457, flash memory device 456 and flash memory device 455.

In this configuration, flash memory devices 451, 452, 453, 454, 455, 456, 457, 458 are controlled in groups of two where each group of two flash memory devices are controlled by common chip enable and command/response signals. The data buses operate in groups of four such that four flash memory devices are coupled to a common data bus that is the width of the data bus supported by one of the respective memory devices 451, 452, 453, 454, 455, 456, 457, 458. As an example, where each flash memory device has an eight bit data bus, the configuration of memory system 405 supports two eight bit data buses operating in parallel. Following the example, where each of flash memory devices 451, 452, 453, 454, 455, 456, 457, 458 requires one hundred, fifty microseconds to access a 4K block of data, is capable of supporting 27 MHz of bandwidth and 6.66K IOPS, the configuration of memory system 405 supports 54 MHz of bandwidth (i.e., 27 MHz times two data buses) and 26.6K IOPS (i.e., 6.66 IOPS times four independently accessible groups of memory devices).

Turning to FIG. 4f, a memory system 406 is depicted that includes a clock input 411 that is distributed to each of eight flash memory devices 451, 452, 453, 454, 455, 456, 457, 458. The switch selection registers discussed above in relation to FIG. 3b are set such that chip enable 461 is electrically coupled to the chip enable input of flash memory device 454; chip enable 462 is electrically coupled to the chip enable input of flash memory device 453; chip enable 463 is electrically coupled to the chip enable input of flash memory device 452; chip enable 464 is electrically coupled to the chip enable input of flash memory device 451; chip enable 465 is electrically coupled to the chip enable input of flash memory device 458; chip enable 466 is electrically coupled to the chip enable input of flash memory device 457; chip enable 467 is electrically coupled to the chip enable input of flash memory device 456; and chip enable 468 is electrically coupled to the chip enable input of flash memory device 455. The switch selection registers discussed above in relation to FIG. 3c are set such that command/response signal 471 is electrically coupled to the command/response input of flash memory device 454; command/response signal 472 is electrically coupled to the command/response input of flash memory device 453; command/response signal 473 is electrically coupled to the command/response input of flash memory device 452; command/response signal 474 is electrically coupled to the command/response input of flash memory device 451; command/response signal 475 is electrically coupled to the command/response input of flash memory device 458; command/response signal 476 is electrically coupled to the command/response input of flash memory device 457; command/response signal 477 is electrically coupled to the command/response input of flash memory device 456; and command/response signal 478 is electrically coupled to the command/response input of flash memory device 455. The switch selection registers discussed above in relation to FIG. 3d are set such that data bus 481 is electrically coupled to all four of the data buses of flash memory device 454, flash memory device 453, flash memory device 452, and flash memory device 451; and data bus 485 is electrically coupled to all four of the data buses of flash memory device 458, flash memory device 457, flash memory device 456 and flash memory device 455.

In this configuration, flash memory devices 451, 452, 453, 454, 455, 456, 457, 458 are each controlled individually with each of the memory devices receiving independent chip enable and command/response signals. The data buses operate in groups of four such that four flash memory devices are coupled to a common data bus that is the width of the data bus supported by one of the respective memory devices 451, 452, 453, 454, 455, 456, 457, 458. As an example, where each of flash memory devices 451, 452, 453, 454, 455, 456, 457, 458 has an eight bit data bus, requires one hundred, fifty microseconds to access a 4K block of data, is capable of supporting 27 MHz of bandwidth and 6.66K IOPS, the configuration of memory system 404 supports 54 MHz of bandwidth (i.e., 27 MHz times four data buses) and 53.3K IOPS (i.e., 6.66 IOPS times eight independently accessible memory devices).

Turning to FIG. 5, a flow diagram 500 depicts a method in accordance with one or more embodiments for configuring a switchable memory. Following flow diagram 500, a desired memory configuration is determined (block 505). Such determination may be made by combining a determination of a maximum number of input/output (i.e., pin count) that can be supported, a desired number of IOPS, and a desired bandwidth. Once the configuration is determined (block 505), connections in the cross-bar switch that are needed to implement the configuration are selected (block 510) and programmable registers are written to effectuate the connection (block 515)

It should be noted that the configurations discussed above in relation to FIGS. 4a-4f are merely examples, and that based upon the disclosure provided herein one of ordinary skill in the art will recognize a myriad of other memory configurations that are possible in accordance with different embodiments. Each of the different configurations may be achieved by writing defined values to programmable control registers 315. Further, each of the configurations will provide a different balance between bandwidth, IOPS and pin count. This balance may be tailored for a particular implementation. Such an approach allows for, for example, development of a particular memory system that can be programmed at a later point to provide a desired configuration.

In conclusion, the disclosure sets forth novel systems, devices, methods and arrangements for use of a memory system. While detailed descriptions of one or more embodiments have been given above, various alternatives, modifications, and equivalents will be apparent to those skilled in the art without varying from the spirit of the disclosure. Based upon the disclosure provided herein, one of ordinary skill in the art will recognize other implementations. Therefore, the above description should not be taken as limiting the scope of the disclosure, which is defined by the appended claims.

What is claimed is:

1. A memory system, the system comprising:
a plurality of memory devices; and
a configuration circuit having at least one input, a plurality of outputs, and a programmable control circuit; wherein the plurality of outputs are communicably coupled to the plurality of memory devices; and wherein the programmable control circuit is operable to selectably couple the input to at least one of the plurality of outputs.

2. The memory system of claim 1, wherein the plurality of memory devices is a plurality of flash memory devices.

3. The memory system of claim 1, wherein the input is a host data bus input/output, wherein the plurality of memory devices includes a first memory device and a second memory device, wherein the first memory device includes a first data bus input/output, wherein the second memory device includes a second data bus input/output, wherein the plurality of outputs includes a first data bus output communicably coupled to the first data bus input/output and a second data bus output communicably coupled to the second data bus input/output, and wherein the programmable control circuit selectably couples the host data bus input/output to one or both of the first data bus output and the second data bus output.

4. The memory system of claim 1, wherein the input is a host chip enable input, wherein the plurality of memory devices includes a first memory device and a second memory device, wherein the first memory device includes a first chip enable input, wherein the second memory device includes a second chip enable input, wherein the plurality of outputs includes a first chip enable output communicably coupled to the first chip enable input and a second data bus output communicably coupled to the second chip enable input, and wherein the programmable control circuit selectably couples the host chip enable input to one or both of the first chip enable output and the second chip enable output.

5. The memory system of claim 1, wherein the input is a host command/response input, wherein the plurality of memory devices includes a first memory device and a second memory device, wherein the first memory device includes a first command/response input, wherein the second memory device includes a second command/response input, wherein the plurality of outputs includes a first command/response output communicably coupled to the first command/response input and a second command/response output communicably coupled to the second command/response input, and wherein the programmable control circuit selectably couples the host command/response input to one or both of the first command/response output and the second command/response output.

6. The memory system of claim 1, wherein the configuration circuit includes a cross-bar switch having a plurality of switches controlled by the programmable control circuit.

7. The memory system of claim 6, wherein the programmable control circuit includes a number of writable register values that each correspond to at least one of the plurality of switches.

8. The memory system of claim 1, wherein the input is a host chip enable input, wherein the plurality of memory devices includes a first memory device, a second memory device, a third memory device and a fourth memory device; wherein the first memory device includes a first chip enable input, the second memory device includes a second chip enable input, the third memory device includes a third chip enable input, and the fourth memory device includes a fourth chip enable input; wherein the plurality of outputs includes a first chip enable output communicably coupled to the first chip enable input, a second chip enable output communicably coupled to the second chip enable input, a third chip enable output communicably coupled to the third chip enable input, and a fourth data bus output communicably coupled to the fourth chip enable input; and wherein the programmable control circuit selectably couples the host chip enable input to one or more of the first chip enable output, the second chip enable output, the third chip enable output, and the fourth chip enable output.

9. The memory system of claim 1, wherein the input is a host data bus input/output, wherein the plurality of memory devices includes a first memory device, a second memory device, a third memory device and a fourth memory device; wherein the first memory device includes a first data bus input/output, the second memory device includes a second data bus input/output, the third memory device includes a third data bus input/output, and the fourth memory device includes a fourth data bus input/output; wherein the plurality of outputs includes a first data bus output communicably coupled to the first data bus input/output, a second data bus output communicably coupled to the second data bus input/output, a third data bus output communicably coupled to the third data bus input/output, and a fourth data bus output communicably coupled to the fourth data bus input/output; and wherein the programmable control circuit selectably couples the host data bus input/output to one or more of the first data bus output, the second data bus output, the third data bus output, and the fourth data bus output.

10. The memory system of claim 1, wherein each of the plurality of memory devices is implemented on a separate semiconductor die.

11. The memory system of claim 1, wherein the configuration circuit is implemented on a semiconductor die that is separate a semiconductor die on which one or more of the memory devices is implemented.

12. The memory system of claim 1, wherein each of the plurality of memory devices is implemented in a separate semiconductor package.

13. The memory system of claim 1, wherein the configuration circuit is implemented in a semiconductor package that is separate from a semiconductor package in which one or more of the memory devices is packaged.

14. A method for configuring a switchable memory, the method comprising:
providing a memory system that includes:
a plurality of memory devices; and
a configuration circuit having at least one input, a plurality of outputs, and a programmable control circuit; and wherein the plurality of outputs are communicably coupled to the plurality of memory devices; and
programming the programmable control circuit to selectably couple the input to at least one of the plurality of outputs.

15. The method of claim 14, wherein the configuration circuit includes a cross-bar switch having a plurality of switches controlled by the programmable control circuit.

16. The method of claim 15, wherein the programmable control circuit includes a number of writable register values that each correspond to at least one of the plurality of switches, and wherein programming the programmable control circuit includes writing one or more of the writable register values.

17. A circuit, the circuit comprising:
a plurality of memory circuits, wherein each of the plurality of memory circuits is accessible via a memory circuit data bus; and
a configuration circuit having at least one host data bus input/output, a plurality of configuration data bus input/outputs, and a programmable control circuit; wherein the plurality of configuration data bus input/outputs are communicably coupled to the plurality of memory circuit data buses; and wherein the programmable control circuit selectably couples the host data bus input/output to at least one of the plurality of configuration data bus input/outputs.

18. The circuit of claim 17, wherein the configuration circuit includes a cross-bar switch having a plurality of switches controlled by the programmable control circuit.

19. The circuit of claim 18, wherein the programmable control circuit includes a number of writable register values that each control at least one of the plurality of switches.

20. The circuit of claim 17, wherein the plurality of memory circuits is a plurality of flash memory circuits.
